(19) United States
(12) Patent Application Publication
(10) Pub. No.: US 2025/0304203 A1
(43) Pub. Date: Oct. 2, 2025

(54) SADDLE-RIDE VEHICLE

(71) Applicant: HONDA MOTOR CO., LTD., Tokyo (JP)

(72) Inventors: Takahiro Matsumoto, Tokyo (JP); Kotaro Tsuji, Tokyo (JP); Hirokazu Kanetani, Tokyo (JP); Hiroaki Yoshida, Tokyo (JP); Takeshi Kawatani, Tokyo (JP)

(21) Appl. No.: 19/089,070

(22) Filed: Mar. 25, 2025

(30) Foreign Application Priority Data
Mar. 28, 2024 (JP) 2024-053668

(51) Int. Cl. B62J 43/28; B62J 50/21

(52) U.S. Cl. CPC B62J 43/28; B62J 50/225

(57) ABSTRACT

A saddle-ride vehicle includes an information display unit, a power supply unit, and a lid member. The information display unit has a display surface configured to display a state of a vehicle. The power supply unit has a terminal insertion portion to which a connection terminal of an external device is capable of being inserted. The lid member is detachable from the terminal insertion portion. The power supply unit is disposed on a side of a back surface of the information display unit facing an opposite direction to the display surface with a gap interposed between the power supply unit and at least a part of the back surface. The lid member is capable of transitioning between an attached state of being attached to the terminal insertion portion and a fixed state of being fixed to the gap between the information display unit and the power supply unit.

### CROSS-REFERENCE TO RELATED APPLICATION

Priority is claimed on Japanese Patent Application No. 2024-053668, filed in Japan on Mar. 28, 2024, the entire content of which is incorporated herein by reference.

### BACKGROUND OF THE INVENTION

### Field of the Invention

The present invention relates to a saddle-ride vehicle.

### Description of Related Art

In a saddle-ride vehicle such as a motorcycle, an information display panel (information display unit) that displays various vehicle states such as a traveling speed, a remaining fuel amount, and a traveling distance is installed in a substantially central region of a steering handlebar in a vehicle width direction. In recent years, in this type of saddle-ride vehicle, it is desired to dispose a power supply unit such as a USB charger on a back surface side of a display surface of the information display panel so that an external device such as a smartphone can be charged at a position where a driver can easily reach.

The power supply unit such as a USB charger has a terminal insertion portion for connecting a connection terminal of the external device. In the terminal insertion portion, in a case where the connection terminal of the external device is removed, a connection port is directly opened to the outside. Therefore, it is desirable to close the opening portion with another member after the connection terminal is removed.

As a technique of a device having a terminal insertion portion, there has been devised a device in which a lid member (cover member) covering the outside of the terminal insertion portion is provided with a tongue piece portion that is bendable and deformable, and the tongue piece portion is coupled to a housing so as to be drawable (for example, refer to Patent Document 1).

In a case where the connection terminal of the external device is connected to the terminal insertion portion, the tongue piece portion of the lid member of the device is opened outward as a hinge fulcrum, and in a case where the connection terminal of the external device is not connected to the terminal insertion portion, the lid member of the device is closed so as to cover the outside of the terminal insertion portion.
[Patent Document 1] Japanese Unexamined Patent Application, First Publication No. 2010-238660

### SUMMARY OF THE INVENTION

In a saddle-ride vehicle such as a motorcycle, a large load is frequently input to a vehicle body by acceleration/deceleration, steering, or the like of the vehicle in addition to vibration or traveling vibration of a vehicle drive unit being constantly input. Therefore, in a case where the technique of the lid member disclosed in Patent Document 1 is applied as it is to the above-described saddle-ride vehicle, when the connection terminal of the external device is connected to the terminal insertion portion, a lid main body portion of the lid member supported via the tongue piece portion easily swings. In this case, there is a possibility that the lid main body portion comes into contact with a surrounding device to generate a contact sound, and thus it is necessary to take measures such as using a member that is less susceptible to vibration, for the tongue piece portion.

An aspect according to the present invention has been made in view of the above problem, and an object thereof is to provide a saddle-ride vehicle capable of reliably restricting swinging movement of the lid member at a portion not easily visible to a rider when the attachment of the lid member is released from the terminal insertion portion of the power supply unit.

In order to solve the above problem and achieve the object, the present invention adopts the aspects described below.

<1> A saddle-ride vehicle according to an aspect of the present invention includes an information display unit having a display surface configured to display a state of a vehicle; a power supply unit having a terminal insertion portion to which a connection terminal of an external device is capable of being inserted; and a lid member that is detachable from the terminal insertion portion, in which the power supply unit is disposed on a side of a back surface of the information display unit facing an opposite direction to the display surface with a gap interposed between the power supply unit and at least a part of the back surface, and the lid member is capable of transitioning between an attached state of being attached to the terminal insertion portion and a fixed state of being fixed to the gap between the information display unit and the power supply unit.

With this configuration, when the lid member is not attached to the terminal insertion portion, since the lid member is fixed to the gap between the information display unit and the power supply unit, the lid member is maintained in a stable state, and even in a case of receiving vibration or impact from the outside, the lid member is less shaken.

When the lid member is not attached to the terminal insertion portion, since the lid member is fixed on the back surface side of the display surface of the information display unit, the lid member is less visible to the user who views the display surface of the information display unit, and the appearance is improved. Since the power supply unit is positioned on the back surface side of the information display unit, raindrops and the like are less likely to directly hit the terminal insertion portion even when the connection terminal of the external device is inserted into the terminal insertion portion of the power supply unit and used.

<2> In the above aspect <1>, the power supply unit may include a sliding guide surface capable of guiding the lid member to a fixing position in the gap, at a position facing the back surface of the information display unit, and the terminal insertion portion on a surface intersecting the sliding guide surface.

In this case, since the surface provided with the terminal insertion portion is provided on the surface intersecting the sliding guide surface that guides the lid member to the fixing position, the separation width between the information display unit and the power supply unit is reduced, and the power supply unit can be compactly disposed on the back surface side of the information display unit.

<3> In the above aspect <1> or <2>, a fixing stay that fixes the back surface side of the information display unit to a vehicle body may be further provided, in which in the fixed state, at least a part of the lid member may be spaced apart outward in a vehicle width direction from an outer side of the fixing stay disposed on the same side in the vehicle width direction on the basis of a center in the vehicle width direction.

In this case, when the lid member is in the fixed state, at least a part of the lid member is spaced apart outward in the vehicle width direction from the outer side of the fixing stay disposed on the same side in the vehicle width direction. Therefore, when the user grips the lid member and causes the lid member to transition between the fixed state and the attached state, the fingertip of the user is less likely to interfere with the fixing stay. Therefore, in a case where this configuration is adopted, operability of the lid member is improved.

<4> In the above aspect <3>, the lid member may have a lid main body portion attached to the terminal insertion portion, and in the fixed state, the lid main body portion may be accommodated in the gap, a separation distance between a top wall of the lid main body portion and the back surface may be smaller than a separation distance between the back surface and the fixing stay, and a separation distance between a lower surface portion of the lid main body portion and the power supply unit may be smaller than a separation distance between the power supply unit and the fixing stay.

In this case, in the fixed state, the distance (width) between an upper surface of the lid main body portion and the information display unit is set to be smaller than the distance between the information display unit and the fixing stay, and the distance between the lower surface of the lid main body portion and the power supply unit is set to be smaller than the distance between the power supply unit and the fixing stay. Therefore, in the fixed state, when the lid main body portion is inserted into the gap, the lid main body portion approaches the information display unit and the power supply unit, so that the lid member is easily fixed in a stable manner.

<5> In the above aspect <4>, in the fixed state, the lid member may be fixed such that a center of the lid main body portion as viewed in an attachment direction is offset from an insertion/removal center axis of the terminal insertion portion to a side away from the fixing stay.

In this case, when the lid member is in the fixed state, the lid main body portion is maintained in a state of being offset outward in the vehicle width direction so as to be spaced from the fixing stay. Therefore, even in a case where the power supply unit is disposed sufficiently close to the fixing stay, the transition of the lid main body portion to the fixed state is not hindered by the fixing stay. Therefore, in a case where this configuration is adopted, the power supply unit can be disposed more compactly on the back surface side of the information display unit.

In the above aspect <5>, the power supply unit may be provided with a support protrusion in a protruding manner, on the sliding guide surface, the lid member may include the lid main body portion, and a tongue piece portion coupled to the lid main body portion in a bendable and deformable manner, the tongue piece portion may include a guide hole that extends along a longitudinal direction of the tongue piece portion and is slidably and rotatably engaged with the support protrusion, and a cutout surface provided on a corner portion of the tongue piece portion on a side opposite to a coupling portion with the lid main body portion and on a side close to the fixing stay, and the cutout surface may abut on the fixing stay in the fixed state.

In this case, when the lid member is in the attached state, the tongue piece portion of the lid member is engaged with the support protrusion in a state of abutting on the sliding guide surface, and in this state, the lid main body portion is attached to the terminal insertion portion. In a case where the lid member transitions from this state to the fixed state, the coupling portion between the lid main body portion and the tongue piece portion is bent to detach the lid main body portion from the terminal insertion portion, and then the tongue piece portion and the lid main body portion are inserted into the gap between the power supply unit and the information display unit along the sliding guide surface. At this time, the tongue piece portion is moved in a state where the guide hole is guided by the support protrusion. At an appropriate timing during this period, the entire lid member is rotated about the support protrusion such that the lid main body portion is spaced from the fixing stay. As a result, the cutout surface of the tongue piece portion positioned on a side opposite to the lid main body portion abuts on the fixing stay. As a result, the lid member is fixed in a stable state in the gap without the insertion of the lid main body portion into the gap being hindered by the fixing stay.

<7> In the above aspect <6>, when the lid member is in the attached state, the guide hole of the tongue piece portion is formed such that a center axis in an extending direction of the guide hole is substantially parallel to the insertion/removal center axis of the terminal insertion portion and is offset from the insertion/removal center axis to a side away from the fixing stay.

In this case, when the lid member is in the attached state, the center axis in the extending direction of the guide hole is substantially parallel to the insertion/removal center axis of the terminal insertion portion, so that the lid main body portion can be attached to and detached from the terminal insertion portion without being hindered by the support protrusion.

When the lid member is in the attached state, the center axis in the extending direction of the guide hole is offset from the insertion/removal center axis of the terminal insertion portion to a side away from the fixing stay. Therefore, the support protrusion engaged with the guide hole is also offset from the insertion/removal center axis to the same side as the center axis in the extending direction of the guide hole by the same distance. Therefore, when the lid member transitions from the attached state to the fixed state, in a case where the lid member is rotated about the support protrusion, the lid main body portion of the lid member can be further spaced from a part of the fixing stay. Therefore, in a case where this configuration is adopted, it is possible to prevent the movement of the lid main body portion from being hindered by the fixing stay while the lid member transitions to the fixed state. As a result, the power supply unit can be brought closer to the fixing stay, and the power supply unit can be disposed more compactly on the back surface side of the information display unit.

<8> In the above aspect <6> or <7>, a covering member that is fixed to the fixing stay is further provided between the fixing stay and the information display unit, in which an attachment side thickness of the lid main body portion is set to be thicker than a thickness of the tongue piece portion in a direction orthogonal to the sliding guide surface, and in the fixed state, the lid main body portion abuts on the covering member, and the tongue piece portion abuts on the fixing stay.

In this case, when the lid member is in the fixed state, the lid main body portion and the tongue piece portion having different thicknesses can be stably positioned and fixed by the contact surfaces of the covering member and the fixing stay.

<9> In the above aspects <6> to <8>, the guide hole of the tongue piece portion may include a first hole region engaged with the support protrusion until the lid member transitions from the attached state to the fixed state, a second hole region engaged with the support protrusion when the lid member has transitioned to the fixed state, and a constricted portion that is between the first hole region and the second hole region and has a width in a direction intersecting an extending direction of the guide hole narrower than other portions, and when the lid member transitions from the attached state to the fixed state, the support protrusion may go over the constricted portion to be engaged with the second hole region.

In this case, when the lid member transitions from the attached state to the fixed state, the support protrusion goes over the constricted portion to be engaged with the second hole region. At this time, after the support protrusion once enters the second hole region, the return is restricted by the constricted portion. Therefore, a state in which the orientation of the lid main body portion is changed and the lid main body portion rides on the sliding guide surface is stably maintained, and the lid member can be stably rotated. Therefore, after the lid member has transitioned to the fixed state, the lid main body portion is more stably fixed, and the connection terminal of the external device is easily inserted into the terminal insertion portion.

<10> In the above aspects <6> to <9>, a convex portion for finger hooking may be formed on a side surface of the lid main body portion at a position opposite to the coupling portion with the tongue piece portion.

Therefore, when the lid main body portion is removed from the terminal insertion portion, the operator can easily remove the lid main body portion from the terminal insertion portion by hooking a finger on the convex portion for finger hooking.

According to the aspects of the present invention, it is possible to provide a saddle-ride vehicle capable of reliably restricting swinging movement of the lid member at a portion not easily visible to a rider when the attachment of the lid member is released from the terminal insertion portion of the power supply unit.

### BRIEF DESCRIPTION OF THE DRAWINGS

FIG. 1 is a left side view of a saddle-ride vehicle of an embodiment;

FIG. 2 is an enlarged partial cross-sectional side view of a portion II in FIG. 1;

FIG. 3 is a plan view of a front region (a central region of a bar handle) of the saddle-ride vehicle of the embodiment as viewed from above;

FIG. 4 is a view taken along an arrow IV in FIG. 2, illustrating the saddle-ride vehicle of the embodiment with an information display unit removed, and is a view when a lid member is in an attached state;

FIG. 5 is a view taken along an arrow IV in FIG. 2, illustrating the saddle-ride vehicle of the embodiment with an information display unit removed, and is a view when a lid member is in a fixed state;

FIG. 6 is a plan view of a part of a power supply unit (USB charger) of the embodiment;

FIG. 7 is a plan view of the lid member of the embodiment;

FIG. 8 is a side view of the lid member of the embodiment;

FIG. 9 is a perspective view of the power supply unit (USB charger) of the embodiment to which the lid member is attached as viewed from above; and

FIG. 10 is a perspective view of the power supply unit (USB charger) of the embodiment to which the lid member is attached as viewed from below.

### DETAILED DESCRIPTION OF THE INVENTION

Hereinafter, embodiments of the present invention will be described with reference to the drawings.

Orientations such as front, rear, left, and right indicated in the following description are the same as the orientations with respect to a vehicle to be described below, unless otherwise described. An arrow FR indicating a front side of the vehicle, an arrow LH indicating a left side of the vehicle, an arrow UP indicating an upper side of the vehicle, and a line CL indicating a vehicle body left-right center are illustrated at appropriate positions in the drawings.

In the following description, the “inner side in the vehicle width direction” means a side closer to a vehicle body left-right center CL in the vehicle width direction (left-right direction), and the “outer side in the vehicle width direction” means a side farther from the vehicle body left-right center CL.

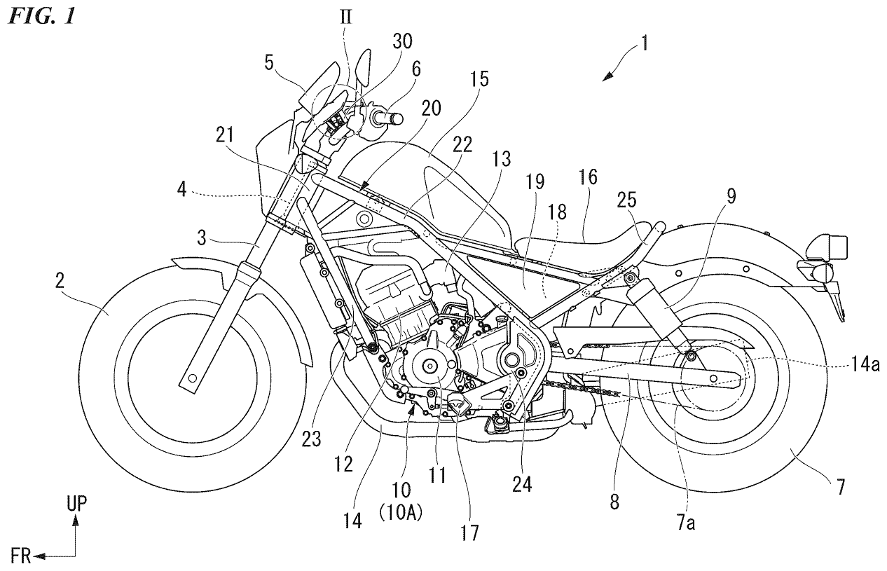

FIG. 1 is a left side view of a motorcycle 1 that is one form of a saddle-ride vehicle.

The motorcycle 1 is a cruiser-type vehicle having a low and long vehicle body. A front wheel 2 of the motorcycle 1 is supported by lower end portions of a pair of left and right front forks 3 inclined such that an upper portion is on the rear side, at the front portion of the vehicle body. The upper portions of the left and right front forks 3 are supported by a front end portion of a vehicle body frame 20 via a steering stem 4. A steering bar handle 6 is attached to an upper portion of the steering stem 4 so as to be able to be steered. A front cowl 5 that covers the front side of the central region of the bar handle 6 in the vehicle width direction is attached to the upper portion of the steering stem 4.

A rear wheel 7 of the motorcycle 1 is supported by a rear end portion of a swing arm 8 extending forward and rearward, at the lower side of the rear portion of the vehicle body. The front end portion of the swing arm 8 is supported on the lower side of the rear portion of the vehicle body frame 20 so as to be swingable up and down. The rear wheel 7 is coupled to a power unit 10A which is a prime mover of the motorcycle 1 via, for example, a chain transmission mechanism 7a disposed on the right side of the rear portion of the vehicle body. The lower end portions of a pair of left and right rear cushions 9 are coupled to the rear portions of left and right arm portions of the swing arm 8.

The power unit 10A is mounted inside the vehicle body frame 20. The power unit 10A includes an engine (internal combustion engine) 10 having a crankshaft along the vehicle width direction (left-right direction). The engine 10 has a cylinder 12 standing upright above a front portion of a crankcase 11. The rear portion of the crankcase 11 is a transmission case that houses a transmission.

An intake passage 13 including a throttle portion and the like is connected to the rear portion of the cylinder 12. A base end portion of an exhaust pipe 14 is connected to the front portion of the cylinder 12. The exhaust pipe 14 is curved rearward in front of the engine 10, is routed rearward below the engine 10, and is connected to, for example, an exhaust muffler 14a disposed on the right side of the rear portion of the vehicle body.

A fuel tank 15 that stores fuel is disposed above the engine 10. A seat 16 on which a driver sits is disposed behind the fuel tank 15. A pair of left and right foot rests 17 on which the driver's feet are placed is disposed below and in front of the seat 16.

Auxiliary equipment 18 such as an air cleaner is disposed below the seat 16. The auxiliary equipment 18 is supported inside the vehicle body frame 20, and is covered from the left and right outer sides by side covers 19 attached to the vehicle body frame 20.

The vehicle body frame 20 includes a head pipe 21 that is positioned at the front end portion thereof and supports the steering stem 4, a pair of left and right main frames 22 that branches to the left and right from the rear side of the upper portion of the head pipe 21 and extends downward and rearward in a side view, a pair of left and right down frames 23 that branches to the left and right from the rear side of the lower portion of the head pipe 21 and extends rearward and downward with a steeper inclination than the main frames 22 in a side view, a pair of left and right pivot frames 24 that is joined to the rear portions of the left and right main frames 22 and supports the front end portion of the swing arm 8, and a seat frame 25 that has a front end portion joined to the rear upper portions of the main frames 22 and extends rearward.

The vehicle body frame 20 has a so-called diamond frame structure using the engine 10 (power unit 10A) as a part of the frame structure. The engine 10 is mounted to be surrounded by the main frame 22, the down frame 23, and the pivot frame 24 in a side view, and couples the lower portion of the down frame 23, the rear portion of the main frame 22, and the pivot frame 24.

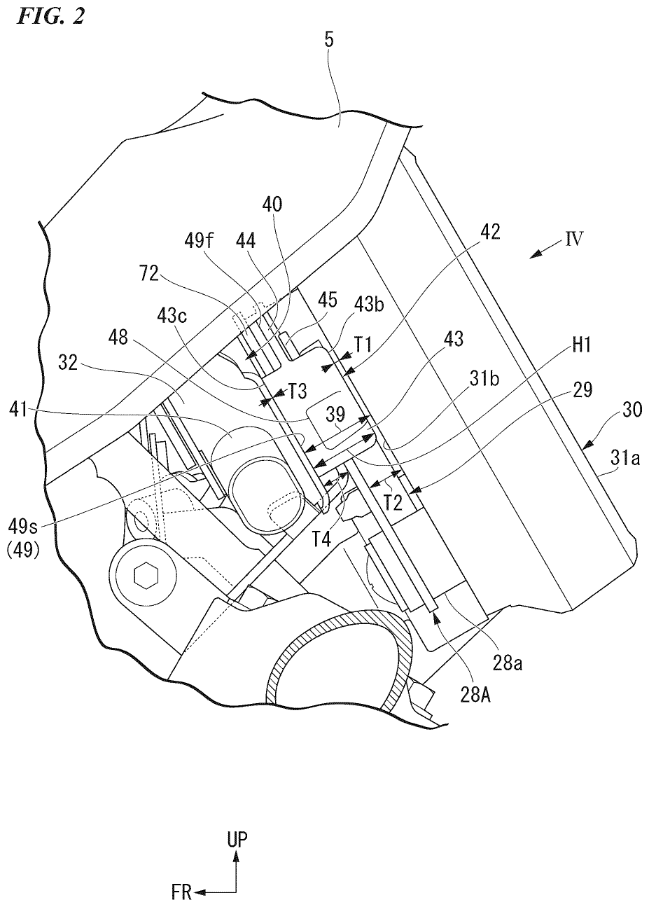

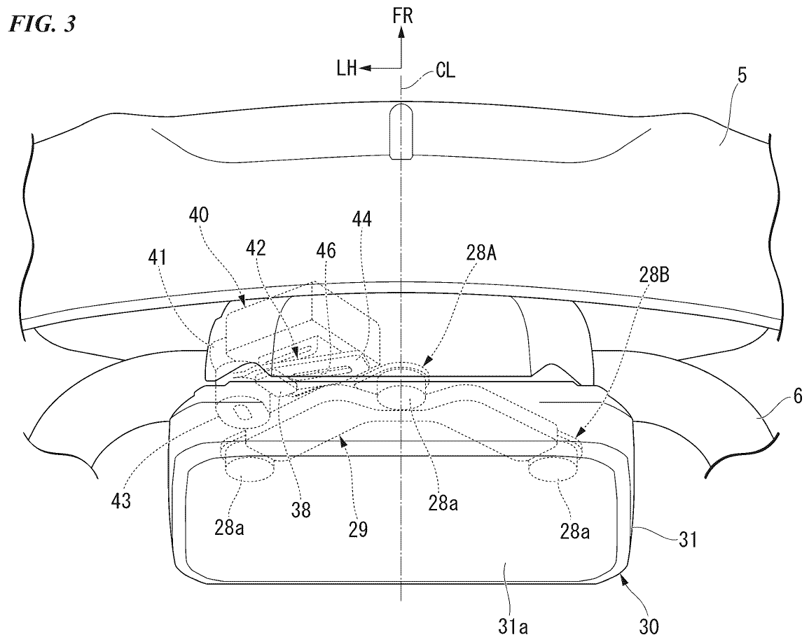

FIG. 2 is an enlarged partial cross-sectional side view of a portion II in FIG. 1. FIG. 3 is a plan view of a front region (a central region of the bar handle 6) of the motorcycle 1 as viewed from above.

An information display unit 30 is fixedly installed on the upper portion of the steering stem 4 (See FIG. 1.) via fixing stays 28A and 28B. The information display unit 30 includes a unit housing 31 having a horizontally long rectangular shape in plan view, and an upper surface side of the unit housing 31 is a display surface 31a. A side of a back surface 31b of the unit housing 31 facing the opposite direction to the display surface 31a is coupled and fixed to the three boss portions 28a of the fixing stays 28A and 28B. The three boss portions 28a support a substantially central position in a width direction on the front side of the back surface 31b of the unit housing 31 and left and right side positions on the rear side of the back surface 31b of the unit housing 31. A covering member 29 for covering an air circulation hole 31c provided on the back surface 31b of the unit housing 31, from at least the unit housing 31 side is fixed to the stay 28 so as to have a slight gap from the information display unit 30. However, the back surface 31b of the unit housing 31 may or may not include a distal end surface (not illustrated) of the air circulation hole 31c.

The display surface 31a of the information display unit 30 is configured by, for example, a liquid crystal display. The information display unit 30 acquires various kinds of information of the vehicle such as a traveling speed, a remaining fuel amount, and a traveling distance from a sensor of each unit of the vehicle, and displays the information on the display surface 31a.

A USB charger 40, which is a form of the power supply unit, is attached to a part of the fixing stay 28A installed on the upper portion of the steering stem 4. The USB charger 40 is formed in a substantially long rectangular parallelepiped shape elongated in one direction as a whole, and a terminal insertion portion 41 into which a connection terminal of an external device such as a mobile terminal is inserted in a detachable manner is provided in a protruding manner at one end portion of the USB charger 40 in a longitudinal direction. The USB charger 40 is installed on the back surface 31b side of the information display unit 30 with a gap 39 interposed between the USB charger 40 and the back surface 31b.

In the case of the present embodiment, as illustrated in FIG. 3, the USB charger 40 is fixed to the fixing stay 28A disposed on the left side of the vehicle with respect to the vehicle body left-right center CL (center in the vehicle width direction). The USB charger 40 is disposed substantially parallel to the left outer side of the fixing stay 28A. In the USB charger 40 fixed to the fixing stay 28A, an insertion port of the terminal insertion portion 41 faces left rear lower side. In this state, the USB charger 40 is disposed such that the longitudinal direction is inclined to the left rear lower side with respect to the upper side and the lower side of the unit housing 31 of the information display unit 30.

As a result, in the information display unit 30, the upper side and the lower side are substantially horizontal, and the visibility of information from the driver is improved, and in the USB charger 40, the insertion port of the terminal insertion portion 41 faces obliquely downward, so that the waterproof property is improved.

In the USB charger 40, a lid member 42 attached to the terminal insertion portion 41 is locked to close the insertion port of the terminal insertion portion 41 when not in use (when the connection terminal of the external device is not inserted into the terminal insertion portion 41). The lid member 42 is formed of a bendable and deformable resin member. As will be described in detail later, the lid member 42 can transition between a fixed state in which the lid member 42 is attached to the terminal insertion portion 41 and a fixed state in which the lid member 42 is detached from the terminal insertion portion 41 and is fixed to the gap 39 between the USB charger 40 and the information display unit 30.

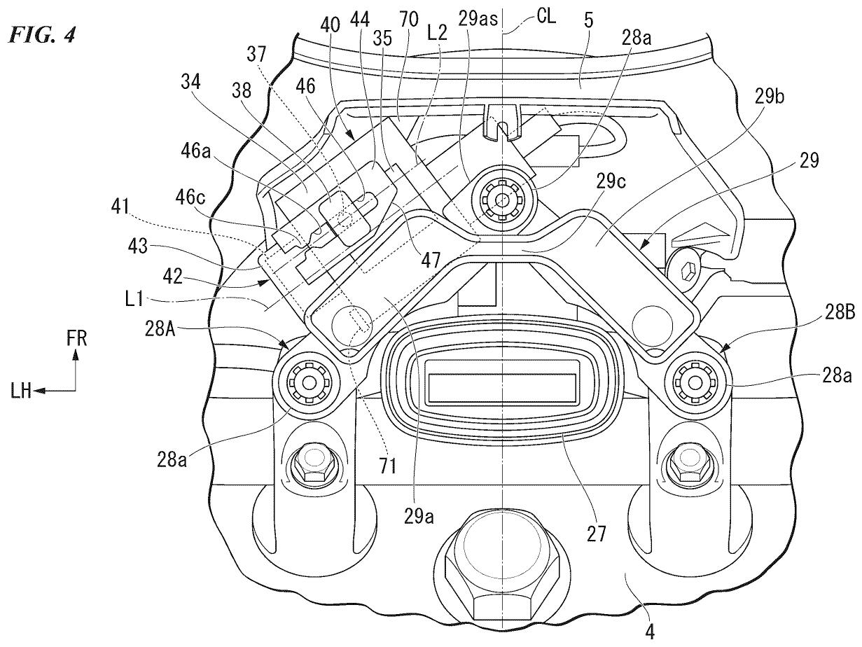

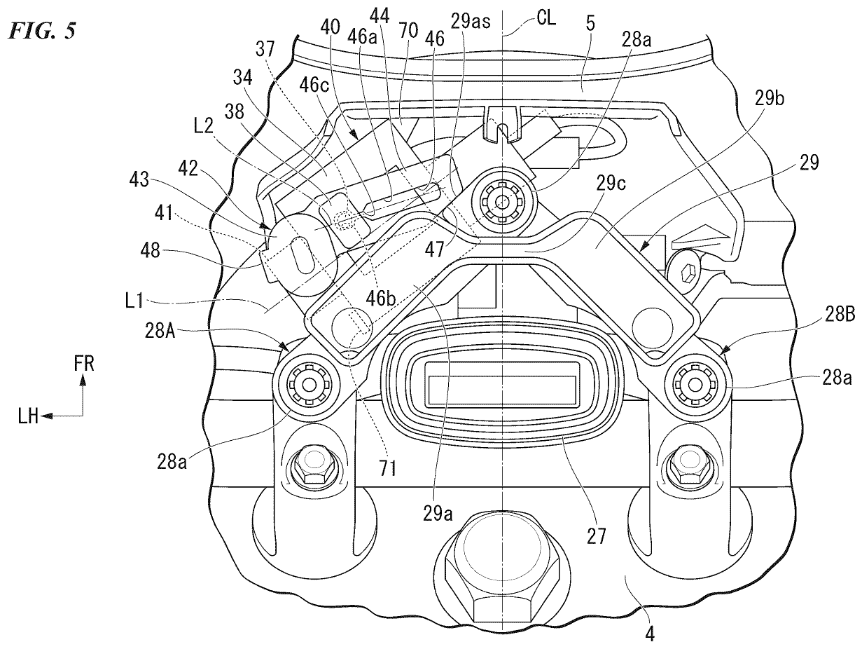

FIG. 4 is a view taken along an arrow IV in FIG. 2, in which the information display unit 30 is removed, and is a view when the lid member 42 is in the attached state. FIG. 5 is a view taken along an arrow IV in FIG. 2, in which the information display unit 30 is removed, and is a view when the lid member 42 is in the fixed state.

As illustrated in FIGS. 4 and 5, the two fixing stays 28A and 28B are disposed to be inclined outward in the vehicle width direction toward the rear lower side with one boss portion 28a positioned at the vehicle body left-right center CL as the center. One fixing stay 28A and the other fixing stay 28B are coupled to each other at the position of the boss portion 28a positioned at the vehicle body left-right center CL. In the one fixing stay 28A, an inclined region between the boss portion 28a at the center and the boss portion 28a on the left rear lower side is recessed downward. Similarly, also in the other fixing stay 28B, an inclined region between the boss portion 28a at the center and the boss portion 28a on the right rear lower side is recessed downward.

The covering member 29 includes an inclined piece 29a disposed above the inclined region of the one fixing stay 28A, an inclined piece 29b disposed above the inclined region of the other fixing stay 28B, and a coupling piece 29c that couples front end portions of the inclined pieces 29a and 29b to each other. The covering member 29 is coupled to the one fixing stay 28A and the other fixing stay 28B in the two inclined pieces 29a and 29b.

One inclined piece 29a of the covering member 29 positioned on the vehicle left side is disposed to be substantially at the same angle as the inclination angle of the USB charger 40 installed in the vehicle in the longitudinal direction, that is, to be substantially parallel to the side of the USB charger 40 along the longitudinal direction.

Reference number 27 in FIGS. 4 and 5 denotes a connector on the vehicle body side, for inputting power and signals to the information display unit 30.

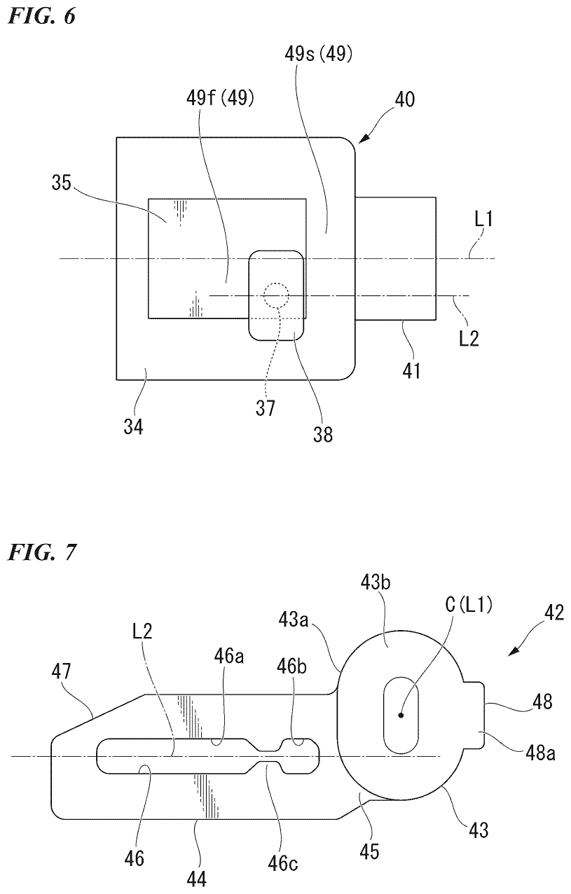

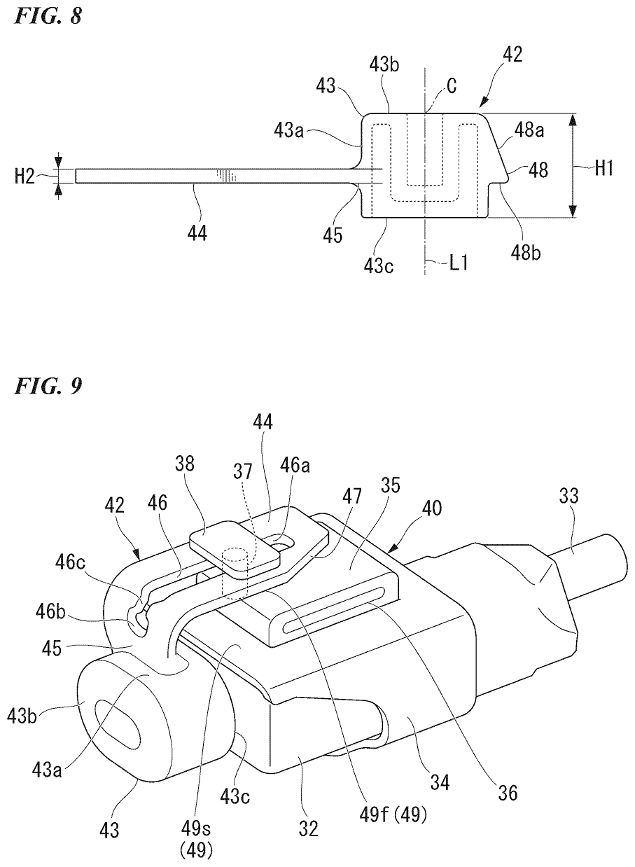

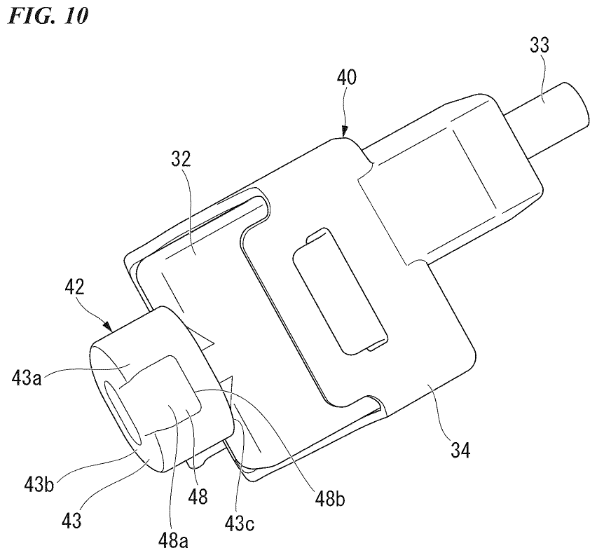

FIG. 6 is a plan view of a part of the USB charger 40. FIGS. 7 and 8 are a plan view and a side view of the lid member 42. FIG. 9 is a perspective view of the USB charger 40 to which the lid member 42 is attached as viewed from above, and FIG. 10 is a perspective view of the USB charger 40 to which the lid member 42 is attached as viewed from below.

In the USB charger 40, the terminal insertion portion 41 having a substantially elliptical shape in a front view is provided in a protruding manner at one end portion of a housing 32, which has a substantially rectangular parallelepiped shape, in the longitudinal direction, and a power supply cable 33 (refer to FIGS. 9 and 10) connected to a battery of the vehicle can be connected to the other end portion in the longitudinal direction. As illustrated in FIGS. 9 and 10, a housing cover 34 is attached to a peripheral region of the housing 32 excluding one end side and the other end side in the longitudinal direction. A projecting portion 35 having a substantially rectangular shape in a top view is provided at the center of the upper surface of the housing cover 34. A locking groove 36 is formed on a side surface of the projecting portion 35, which is orthogonal to a protrusion direction of the terminal insertion portion 41. The locking groove 36 extends in a direction orthogonal to the longitudinal direction of the USB charger 40. A support protrusion piece 72 protruding from the fixing stay 28A can be engaged with the locking groove 36. The USB charger 40 is supported by the fixing stay 28A by inserting the support protrusion piece 72 into the locking groove 36 of the housing cover 34.

As illustrated in FIGS. 4 and 5, the displacement of the USB charger 40 on the front side of the vehicle is restricted by a protrusion portion 70 protruding from the rear surface of the front cowl 5, and the displacement of the USB charger 40 on the rear side of the vehicle is restricted by a displacement restricting piece 71 protruding from the fixing stay 28A. The protrusion portion 70 on the front cowl 5 side abuts on the vicinity of the front corner of the USB charger 40 from the front side of the vehicle, and the displacement restricting piece 71 on the fixing stay 28A side abuts on the vicinity of the front corner of the USB charger 40 from the rear side of the vehicle.

A large load facing the front side of the vehicle acts on the USB charger 40 when the connection terminal is inserted into the terminal insertion portion 41, but the protrusion portion 70 on the front cowl 5 side receives this load. A large load facing the rear side of the vehicle acts on the USB charger 40 when the connection terminal is pulled out from the terminal insertion portion 41, but the displacement restricting piece 71 on the fixing stay 28A side receives this load.

On the upper surface of the projecting portion 35 having a substantially rectangular shape in a top view, a support protrusion 37 having a circular cross section is provided in a protruding manner. A plate-shaped slip-out restricting piece 38 is integrally provided at an extending end of the support protrusion 37. The support protrusion 37 protrudes at a position offset from the insertion/removal center axis L1 (refer to FIG. 6) of the terminal insertion portion 41. The insertion/removal center axis L1 is an axis passing through the insertion center of the terminal insertion portion 41 when the connection terminal of the external device is inserted into the terminal insertion portion 41. Specifically, when the USB charger 40 is fixed to the vehicle body, the support protrusion 37 protrudes at a position offset from the insertion/removal center axis L1 to a side away from the fixing stay 28A by a predetermined distance.

The insertion/removal center axis L1 also coincides with an axis passing through an insertion/removal center (attachment center) of a lid main body portion 43 when the lid main body portion 43 of the lid member 42 described later is attached to the terminal insertion portion 41.

The lid member 42 includes the lid main body portion 43 to be attached to the terminal insertion portion 41 of the USB charger 40, and a tongue piece portion 44 coupled to the lid main body portion 43 in a bendable and deformable manner. The lid member 42 is entirely formed of an elastomer material having elasticity. The lid main body portion 43 is formed in a substantially oval front view shape slightly larger than the terminal insertion portion 41. The lid main body portion 43 includes a substantially elliptical peripheral wall 43a fitted to the outer peripheral surface of the terminal insertion portion 41, a top wall 43b connected to one end portion of the peripheral wall 43a, and a lower surface portion 43c connected to the other end portion of the peripheral wall 43a. The tongue piece portion 44 is connected to the outer surface on the end diameter side of the peripheral wall 43a of the lid main body portion 43.

Hereinafter, the thickness of the lid main body portion 43 in a direction in which the peripheral wall 43a is attached to the terminal insertion portion 41 is referred to as an attachment side thickness H1. A thickness H2 of the tongue piece portion 44 in a plate thickness direction is set to be sufficiently thinner than the attachment side thickness H1 of the lid main body portion 43.

In an initial state of the lid member 42, as illustrated in FIGS. 7 and 8, the tongue piece portion 44 linearly extends from the outer surface of the peripheral wall 43a of the lid main body portion 43 in a direction orthogonal to the outer surface. The lid main body portion 43 is bendable and deformable in the plate thickness direction of the tongue piece portion 44 starting from the vicinity of a coupling portion 45 with the tongue piece portion 44.

The tongue piece portion 44 is a plate-shaped portion having a strip shape with a substantially constant thickness. Hereinafter, a direction in which the tongue piece portion 44 extends long from the outer surface of the peripheral wall 43a of the lid main body portion 43 is referred to as the “longitudinal direction”, and a direction in which the tongue piece portion 44 is orthogonal to the longitudinal direction and the direction of the thickness H2 is referred to as the “width direction”. A guide hole 46 extending along the longitudinal direction is formed substantially at the center of the tongue piece portion 44 in the width direction.

As illustrated in FIG. 7, the tongue piece portion 44 is connected to the lid main body portion 43 such that a center axis L2 in the extending direction of the guide hole 46 is offset to one side in the width direction with respect to a center C1 of the top wall 43b intersecting the insertion/removal center axis L1 of the lid main body portion 43. Specifically, the tongue piece portion 44 is connected to the lid main body portion 43 such that when the USB charger 40 is fixed to the vehicle body, the center axis L2 in the extending direction of the guide hole 46 is offset from the center C1 of the top wall 43b (center of the lid main body portion 43 as viewed in the attachment direction) to a side away from the fixing stay 28A by a predetermined distance.

The guide hole 46 of the tongue piece portion 44 is formed such that the center axis L2 in the extending direction is substantially parallel to the insertion/removal center axis L1 of the terminal insertion portion 41 when the lid member 42 is in the attached state. Therefore, when the lid member 42 is in the attached state, the guide hole 46 is formed such that the center axis L2 in the extending direction is substantially parallel to the insertion/removal center axis L1 of the terminal insertion portion 41 and is offset from the insertion/removal center axis L1 to a side away from the fixing stay 28A.

The support protrusion 37 protruding from the USB charger 40 is inserted into and engaged with the guide hole 46 of the tongue piece portion 44. In the tongue piece portion 44, the guide hole 46 is slidably and rotatably engaged with the support protrusion 37, and in this state, the slip-out of the tongue piece portion 44 is restricted by the slip-out restricting piece 38.

As illustrated in FIG. 7, the guide hole 46 of the tongue piece portion 44 includes a first hole region 46a long in the longitudinal direction, a second hole region 46b short in the longitudinal direction, and a constricted portion 46c provided between the first hole region 46a and the second hole region 46b. The first hole region 46a is positioned on a side of the guide hole 46, which is away from the lid main body portion 43, and the second hole region 46b is positioned on a side of the guide hole 46, which is close to the lid main body portion 43. The separation width of the constricted portion 46c in the width direction is narrower than the separation width of the first hole region 46a and the second hole region 46b in the width direction.

As illustrated in FIGS. 7, 9, and the like, a cutout surface 47 inclined at a predetermined angle with respect to the end surface in the width direction of the tongue piece portion 44 is provided at a corner portion on a side that is opposite to the coupling portion 45 of the tongue piece portion 44 in the longitudinal direction and is close to the fixing stay 28A. The “cutout surface 47” does not mean a surface obtained by cutting out a member as a manufacturing method, but means a surface in which a corner of a corner portion is cut out in a cutout shape. As will be described in detail later, when the lid member 42 is shifted to the fixed state and the lid member 42 is finally rotated clockwise by a predetermined angle, the cutout surface 47 abuts on an outer side 28as of the fixing stay 28A as illustrated in FIG. 5. As a result, the rotation of the lid member 42 in one direction in the fixed state is restricted.

On the outer surface of the peripheral wall 43a of the lid main body portion 43, a convex portion 48 for hanging a finger is integrally formed at a position opposite to the coupling portion 45 with the tongue piece portion 44, as illustrated in FIGS. 7, 8, 10, and the like. The convex portion 48 is formed in a substantially triangular shape in a side view such that a protruding height from the peripheral wall 43a is increased as a separation distance from the top wall 43b of the lid main body portion 43 is increased. The convex portion 48 has an inclined surface 48a of which the protruding height from the peripheral wall 43a is gradually increased, and a finger hooking surface 48b provided at the extending end of the inclined surface 48a to be orthogonal to the outer surface of the peripheral wall 43a. The convex portion 48 for finger hooking is positioned below the peripheral wall 43a of the lid main body portion 43 when the lid main body portion 43 is attached to the terminal insertion portion 41. The user can easily detach the lid main body portion 43 from the terminal insertion portion 41 by hooking a fingertip on the convex portion 48 for finger hooking and pulling up the lid main body portion 43 in this state.

The upper surface of the housing cover 34 of the USB charger 40 illustrated in FIG. 9 serves as a sliding guide surface 49 on which the back surface of the lid member 42 slides when the lid member 42 is guided by the support protrusion 37 to transition between the attached state and the fixed state. Specifically, the upper surface of the projecting portion 35 of the housing cover 34 serves as a first sliding guide surface 49f that slidably guides the lower surface of the tongue piece portion 44 of the lid member 42. A lower flat surface closer to the terminal insertion portion 41 than the projecting portion 35 serves as a second sliding guide surface 49s that slidably guides the back surface (lower surface portion 43c) of the lid main body portion 43 of the lid member 42. The terminal insertion portion 41 protrudes from a side surface intersecting the first sliding guide surface 49f and the second sliding guide surface 49s of the USB charger 40. The sliding guide surface 49 includes the first sliding guide surface 49f and the second sliding guide surface 49s.

When the lid member 42 is in the attached state, as illustrated in FIG. 9, the lid main body portion 43 is attached to the terminal insertion portion 41 by bending the vicinity of the coupling portion 45 between the tongue piece portion 44 and the lid main body portion 43. In a case where the lid member 42 transitions from this state to the fixed state, the lid main body portion 43 is pulled in the distal end side direction of the terminal insertion portion 41 to pull out the lid main body portion 43 from the terminal insertion portion 41. At this time, the tongue piece portion 44 slides on the first sliding guide surface 49f and is slightly moved in the pulling direction together with the lid main body portion 43.

When the lid main body portion 43 is pulled out from the terminal insertion portion 41, the bending in the vicinity of the coupling portion 45 is released, and the lid main body portion 43 springs upward. As a result, the orientation of the attachment side thickness H1 of the lid main body portion 43 is changed to be directed in the up-down direction (direction orthogonal to the sliding guide surface 49). In this state, the operator grips the lid main body portion 43 with his/her fingertip and pushes the lid member 42 into the gap 39 between the back surface 31b of the information display unit 30 and the USB charger 40. In the fixed state, the lid main body portion 43 is inserted into the gap 39 while changing the orientation so that the attachment side thickness H1 coincides with the separation direction of the gap 39.

Here, a separation distance T1 between the upper surface (top wall 43b) of the lid main body portion 43 and the back surface 31b of the information display unit 30 is smaller than a separation distance T2 between the fixing stay 28A and the back surface 31b of the information display unit 30. A separation width between the lower surface portion 43c of the lid main body portion 43 and the USB charger 40, that is, a separation distance T3 between the lower surface portion 43c of the lid main body portion 43 and the second sliding guide surface 49s is smaller than a separation width between the fixing stay 28A and the USB charger 40, that is, a separation distance T4 between the fixing stay 28A and the second sliding guide surface 49s. Therefore, the lid main body portion 43 is stably fixed in the gap 39 by reducing the separation distance from the information display unit 30 and the separation distance from the USB charger 40 in the gap 39 formed by the information display unit 30 and the USB charger 40. In the present embodiment, the attachment side thickness H1 of the lid main body portion 43 is set to be substantially equal to the gap 39 between the information display unit 30 and the USB charger 40. In addition, in the fixed state, the lower surface portion 43c of the lid main body portion 43 abuts on the second sliding guide surface 49s. Therefore, the lid main body portion 43 pushed into the fixing position in the gap 39 is stably fixed by the back surface 31b of the information display unit 30 and the upper surface (first sliding guide surface 49f) of the USB charger 40.

When the lid member 42 transitions from the attached state to the fixed state, the guide hole 46 of the tongue piece portion 44 slides on the support protrusion 37 on the USB charger 40 side, and the sliding contact position with the support protrusion 37 is moved from the first hole region 46a to the second hole region 46b. Then, when the sliding contact position with the support protrusion 37 reaches the end portion of the first hole region 46a, the support protrusion 37 goes over the constricted portion 46c to be engaged with the second hole region 46b. At this time, the lid main body portion 43 of the lid member 42 slides on the second sliding guide surface 49s, and the outer surface of the peripheral wall 43a comes into contact with the outer surface (outer surface in the vehicle width direction) of the inclined piece 29a on the left side of the covering member 29 as illustrated in FIG. 5. The outer surface (outer surface in the vehicle width direction) of the inclined piece 29a on the left side of the covering member 29 is inclined to gradually approach the insertion/removal center axis L1 in the pushing direction of the lid member 42 into the gap 39. As a result, the lid main body portion 43 is gradually pushed to the front side along the outer surface of the inclined piece 29a, and the entire lid member 42 is rotated in the clockwise direction about the support protrusion 37. As a result, the end portion of the tongue piece portion 44 in the pushing direction abuts on an outer side 29as of the covering member 29, on the cutout surface 47.

In this state, as illustrated in FIG. 5, the lid member 42 is disposed such that a part (at least the convex portion 48 for finger hooking) of the lid main body portion 43 is spaced apart outward in the vehicle width direction from the outer side 29as of the covering member 29.

In the present embodiment, the member on which the lid main body portion 43 abuts in the fixed state is constituted by the covering member 29, and the member on which the tongue piece portion 44 abuts in the fixed state is constituted by the fixing stay 28A.

### Effects of Embodiments

As described above, in the motorcycle 1 (saddle-ride vehicle) of the present embodiment, when the lid member 42 is not attached to the terminal insertion portion 41 of the USB charger 40, the lid member 42 is fixed to the gap 39 between the information display unit 30 and the USB charger 40. Therefore, the lid member 42 is maintained in a stable state, and the lid member 42 does not swing even when receiving vibration or impact from the outside. In the motorcycle 1 of the present embodiment, when the lid member 42 is not attached to the terminal insertion portion 41, since the lid member 42 is fixed on the back surface 31b side of the display surface 31a of the information display unit 30, the lid member 42 is less visible to the user who views the display surface 31a of the information display unit 30. Therefore, the appearance from the driver is improved. Furthermore, in the present configuration, since the USB charger 40 is positioned on the back surface 31b side of the information display unit 30, raindrops and the like are less likely to directly hit the terminal insertion portion 41 even when the connection terminal of the external device is inserted into the terminal insertion portion 41 of the USB charger 40 and used. Therefore, it is desirable from the viewpoint of protection of the terminal insertion portion 41 at the time of using the USB charger 40.

Therefore, in a case where the motorcycle 1 (saddle-ride vehicle) of the present embodiment is adopted, it is possible to reliably restrict the swing movement of the lid member 42 at a portion not easily visible to the rider when the attachment of the lid member 42 to the terminal insertion portion 41 of the USB charger 40 is released.

In the motorcycle 1 of the present embodiment, the USB charger 40 includes the sliding guide surface 49 that guides the lid member 42 to the gap 39, at a position facing the back surface 31b of the information display unit 30, and includes the terminal insertion portion 41 on a surface intersecting the sliding guide surface 49. In this configuration, since the surface provided with the terminal insertion portion 41 is provided on the surface intersecting the sliding guide surface 49, the separation width between the information display unit 30 and the USB charger 40 is reduced, and the USB charger 40 can be compactly disposed on the back surface 31b side of the information display unit 30.

Furthermore, in the motorcycle 1 of the present embodiment, when the lid member 42 is in the fixed state, at least a part (for example, the convex portion 48 for finger hooking) of the lid member 42 is spaced apart outward in the vehicle width direction from the outer side of the fixing stay 28A disposed on the same side as the lid member 42 in the vehicle width direction. Therefore, when the user grips the lid member 42 and causes the lid member 42 to transition between the fixed state and the attached state, the fingertip of the user is less likely to interfere with the fixing stay 28A. Therefore, in a case where this configuration is adopted, operability of the lid member 42 is improved.

In the motorcycle 1 of the present embodiment, when the lid member 42 is in the fixed state, the lid main body portion 43 is accommodated in the gap 39, and the separation distance T1 between the upper surface of the lid main body portion 43 and the back surface 31b of the information display unit 30 is smaller than the separation distance T2 between the back surface 31b and the fixing stay 28A. The separation distance T3 between the lower surface of the lid main body portion 43 and the USB charger 40 is smaller than the separation distance T4 between the USB charger 40 and the fixing stay 28A. Therefore, when the lid member 42 is in the fixed state, that is, when the lid main body portion 43 is inserted into the gap 39, the lid main body portion 43 approaches the information display unit 30 and the USB charger 40, so that the lid member 42 is easily fixed in a stable manner.

In the motorcycle 1 of the present embodiment, when the lid member 42 is in the fixed state, the lid member 42 is fixed such that the center C1 of the lid main body portion 43 is offset from the insertion/removal center axis L1 of the terminal insertion portion 41 to a side away from the fixing stay 28A. Therefore, even in a case where the USB charger 40 is disposed sufficiently close to the fixing stay 28A, the transition of the lid main body portion 43 to the fixed state is not hindered by the fixing stay 28A. Therefore, in a case where this configuration is adopted, the USB charger 40 can be disposed more compactly on the back surface 31b side of the information display unit 30.

In the motorcycle 1 of the present embodiment, the lid member 42 includes the lid main body portion 43 and the tongue piece portion 44 that is coupled to the lid main body portion 43 in a bendable and deformable manner, and the tongue piece portion 44 is provided with the guide hole 46 extending along the longitudinal direction of the tongue piece portion 44 and slidably and rotatably engaged with the support protrusion 37 on the USB charger 40 side. The cutout surface 47 is provided on the corner portion of the tongue piece portion 44 on a side close to the fixing stay 28A, at a position on a side opposite to the coupling portion 45 with the lid main body portion 43. Then, in the fixed state, the lid member 42 abuts on the outer side of the fixing stay 28A with the cutout surface 47 as illustrated in FIG. 5.

In this configuration, the entire lid member 42 can be stably guided in the inner direction of the gap 39 when the lid member 42 transitions from the attached state to the fixed state by the guiding function of the support protrusion 37 and the guide hole 46 of the tongue piece portion 44. Then, in the latter stage of the transition to the fixed state, by rotating the lid member 42 about the support protrusion 37, the cutout surface 47 of the corner portion on the extending end side of the tongue piece portion 44 is brought into contact with the outer side of the fixing stay 28A, and thereby the lid member 42 can be fixed in a stable posture. Therefore, in a case where this configuration is adopted, the lid member 42 can be fixed in a stable state in the gap 39 without the insertion of the lid main body portion 43 into the gap 39 being hindered by the fixing stay 28A.

In the motorcycle 1 of the present embodiment, when the lid member 42 is in the attached state, the guide hole 46 is formed such that the center axis L2 in the extending direction of the guide hole 46 is substantially parallel to the insertion/removal center axis L1 of the terminal insertion portion 41 and is offset from the insertion/removal center axis L1 to a side away from the fixing stay 28A. In this case, when the lid member 42 is in the attached state, the center axis L2 in the extending direction of the guide hole 46 is substantially parallel to the insertion/removal center axis L1 of the terminal insertion portion 41, so that the lid main body portion 43 can be attached to and detached from the terminal insertion portion 41 without being hindered by the support protrusion 37.

Furthermore, in this case, when the lid member 42 is in the attached state, the center axis L2 in the extending direction of the guide hole 46 is offset from the insertion/removal center axis L1 of the terminal insertion portion 41 to a side away from the fixing stay 28A. Therefore, the support protrusion 37 engaged with the guide hole 46 is also offset from the insertion/removal center axis L1 to the same side as the center axis L2 in the extending direction of the guide hole 46 by the same distance. Therefore, when the lid member 42 transitions from the attached state to the fixed state, in a case where the lid member 42 is rotated clockwise about the support protrusion 37, the lid main body portion 43 of the lid member 42 can be further spaced from the fixing stay 28A.

Therefore, in a case where this configuration is adopted, it is possible to prevent the movement of the lid main body portion 43 from being hindered by the fixing stay 28A while the lid member 42 transitions to the fixed state. As a result, the USB charger 40 can be brought closer to the fixing stay 28A, and the USB charger 40 can be disposed more compactly on the back surface 31b side of the information display unit 30.

In the motorcycle 1 of the present embodiment, the outer surface (outer surface in the vehicle width direction) of the inclined piece 29a on the left side of the covering member 29 is inclined to gradually approach the insertion/removal center axis L1 in the pushing direction of the lid member 42. Therefore, when the lid member 42 transitions to the fixed state, the outer peripheral surface of the lid main body portion 43 of the lid member 42 comes into sliding contact with the outer surface of the left inclined piece 29a, so that the entire lid member 42 can be pushed and moved in the clockwise direction.

Therefore, in a case where this configuration is adopted, the operator can change the posture of the lid member 42 to the final fixed state in which the cutout surface 47 abuts on the side 29as of the fixing stay 28A only by simply pushing the lid member 42 into the gap 39.

In the motorcycle 1 of the present embodiment, the attachment side thickness H1 of the lid main body portion 43 is set to be thicker than the thickness H2 of the tongue piece portion 44 in the plate thickness direction (thickness in a direction orthogonal to the sliding guide surface 49). When the lid member 42 is in the fixed state, the lid main body portion 43 abuts on the outer side surface of the covering member 29, and the tongue piece portion 44 abuts on the outer side surface of the fixing stay 28A. Therefore, when the lid member 42 is in the fixed state, the lid main body portion 43 and the tongue piece portion 44 having different thicknesses can be stably positioned and fixed by the contact surfaces arranged at appropriate heights of the covering member 29 and the fixing stay 28A.

Furthermore, in the motorcycle 1 of the present embodiment, the guide hole 46 of the tongue piece portion 44 includes the first hole region 46a, the second hole region 46b, and the constricted portion 46c. The first hole region 46a is engaged with the support protrusion 37 until the lid member 42 transitions from the attached state to the fixed state, and the second hole region 46b is engaged with the support protrusion 37 when the lid member 42 has transitioned to the fixed state. The constricted portion 46c is between the first hole region 46a and the second hole region 46b, and has a width in a direction intersecting the extending direction of the guide hole 46 narrower than the other portions (the first hole region 46a and the second hole region 46b). When the lid member 42 transitions from the attached state to the fixed state, the support protrusion 37 goes over the constricted portion 46c to be engaged with the second hole region 46b. Therefore, when the lid member 42 transitions from the attached state to the fixed state, after the support protrusion 37 once enters the second hole region 46b, the return of the lid member 42 is restricted by the constricted portion 46c. As a result, a state in which the orientation of the lid main body portion 43 is changed and the lid main body portion 43 rides on the sliding guide surface 49 is stably maintained, and the lid member 42 can be stably rotated. Therefore, in a case where this configuration is adopted, after the lid member 42 has transitioned to the fixed state, the lid main body portion 43 is more stably fixed, and the connection terminal of the external device is easily inserted into the terminal insertion portion 41.

In the motorcycle 1 of the present embodiment, the convex portion 48 for finger hooking is formed on the side surface of the lid main body portion 43 at a position opposite to the coupling portion 45 with the tongue piece portion 44. Therefore, in a case where this configuration is adopted, when the lid main body portion 43 is removed from the terminal insertion portion 41, the operator can easily remove the lid main body portion 43 from the terminal insertion portion 41 by hooking a finger on the convex portion 48 for finger hooking.

In particular, in the case of the present embodiment, the peripheral wall 43a of the lid main body portion 43 is formed in a substantially oval shape, and the convex portion 48 is provided in a side surface portion of the peripheral wall 43a corresponding to the short diameter direction of the oval and at a portion on a side away from the information display unit 30 (a portion facing downward) such that the finger hooking surface 48b faces downward. Therefore, the operator can more easily remove the lid main body portion 43 from the upper side of the USB charger 40.

The present invention is not limited to the above embodiments, and various design changes can be made without departing from the gist of the present invention. For example, although the panel-shaped information display unit 30 is adopted in the above embodiment, the shape of the information display unit is not particularly limited to the panel shape. The information display unit may have various other shapes as long as the information display unit has the display surface on the upper surface side.

In the above embodiment, the USB charger 40 is used as one form of the power supply unit, but the power supply unit is not limited to the USB charger 40. The power supply unit may have a shape or a function of another standard as long as the power supply unit can supply power to the external device.

Furthermore, in the above embodiment, when the lid member 42 is in the fixed state, the lid member 42 is rotated about the support protrusion 37 and is held at the final fixing position, but the lid member 42 may not be necessarily rotated and held at the fixing position. For example, the lid member 42 may be fixed by being linearly pushed into the gap 39.

In the above embodiment, the motorcycle 1 is adopted as one form of the saddle-ride vehicle, but the saddle-ride vehicle is not limited to the motorcycle 1. Saddle-ride vehicles include all vehicles in which a driver rides on the vehicle body, thus including not only motorcycles (including motorized bicycles and scooter-type vehicles) but also three-wheeled vehicles (including vehicles with two front wheels and one rear wheel as well as vehicles with one front wheel and two rear wheels) and four-wheeled vehicles (four-wheeled buggies and the like).

What is claimed is:

1. A saddle-ride vehicle comprising:
an information display unit having a display surface configured to display a state of a vehicle;
a power supply unit having a terminal insertion portion to which a connection terminal of an external device is capable of being inserted; and
a lid member that is detachable from the terminal insertion portion,
wherein the power supply unit is disposed on a side of a back surface of the information display unit facing an opposite direction to the display surface with a gap interposed between the power supply unit and at least a part of the back surface, and
the lid member is capable of transitioning between an attached state of being attached to the terminal insertion portion and a fixed state of being fixed to the gap between the information display unit and the power supply unit.

2. The saddle-ride vehicle according to claim 1,
wherein the power supply unit includes a sliding guide surface capable of guiding the lid member to a fixing position in the gap, at a position facing the back surface of the information display unit, and the terminal insertion portion on a surface intersecting the sliding guide surface.

3. The saddle-ride vehicle according to claim 2, further comprising:
a fixing stay that fixes the back surface side of the information display unit to a vehicle body,
wherein in the fixed state, at least a part of the lid member is spaced apart outward in a vehicle width direction from an outer side of the fixing stay disposed on the same side in the vehicle width direction on the basis of a center in the vehicle width direction.

4. The saddle-ride vehicle according to claim 3,
wherein the lid member has a lid main body portion attached to the terminal insertion portion,
in the fixed state, the lid main body portion is accommodated in the gap, a separation distance between a top wall of the lid main body portion and the back surface is smaller than a separation distance between the back surface and the fixing stay, and a separation distance between a lower surface portion of the lid main body portion and the power supply unit is smaller than a separation distance between the power supply unit and the fixing stay.

5. The saddle-ride vehicle according to claim 4,
wherein in the fixed state, the lid member is fixed such that a center of the lid main body portion as viewed in an attachment direction is offset from an insertion/removal center axis of the terminal insertion portion to a side away from the fixing stay.

6. The saddle-ride vehicle according to claim 5,
wherein the power supply unit is provided with a support protrusion in a protruding manner, on the sliding guide surface,
the lid member includes
the lid main body portion, and
a tongue piece portion coupled to the lid main body portion in a bendable and deformable manner,
the tongue piece portion includes
a guide hole that extends along a longitudinal direction of the tongue piece portion and is slidably and rotatably engaged with the support protrusion, and
a cutout surface provided on a corner portion of the tongue piece portion on a side opposite to a coupling portion with the lid main body portion and on a side close to the fixing stay, and
the cutout surface abuts on the fixing stay in the fixed state.

7. The saddle-ride vehicle according to claim 6,
wherein when the lid member is in the attached state, the guide hole of the tongue piece portion is formed such that a center axis in an extending direction of the guide hole is substantially parallel to the insertion/removal center axis of the terminal insertion portion and is offset from the insertion/removal center axis to a side away from the fixing stay.

8. The saddle-ride vehicle according to claim 6, further comprising:
a covering member that is fixed to the fixing stay, between the fixing stay and the information display unit,
wherein an attachment side thickness of the lid main body portion is set to be thicker than a thickness of the tongue piece portion in a direction orthogonal to the sliding guide surface, and
in the fixed state, the lid main body portion abuts on the covering member, and the tongue piece portion abuts on the fixing stay.

9. The saddle-ride vehicle according to claim 6,
wherein the guide hole of the tongue piece portion includes
a first hole region engaged with the support protrusion until the lid member transitions from the attached state to the fixed state,
a second hole region engaged with the support protrusion when the lid member has transitioned to the fixed state, and
a constricted portion that is between the first hole region and the second hole region and has a width in a direction intersecting an extending direction of the guide hole narrower than other portions, and
when the lid member transitions from the attached state to the fixed state, the support protrusion goes over the constricted portion to be engaged with the second hole region.

10. The saddle-ride vehicle according to claim 6,
wherein a convex portion for finger hooking is formed on a side surface of the lid main body portion at a position opposite to the coupling portion with the tongue piece portion.
